(19) United States
(12) Patent Application Publication
(10) Pub. No.: US 2014/0346857 A1
(43) Pub. Date: Nov. 27, 2014

(54) PROTECTING AGAINST TRANSIENTS IN A COMMUNICATION SYSTEM

(71) Applicant: VETCO GRAY CONTROLS LIMITED, Nailsea, Bristol (GB)

(72) Inventors: Silviu Puchianu, Nailsea (GB); Graham Morley, Nailsea (GB); Hilton Smart, Nailsea (GB); Steven Lewis Charles Simpson, Nailsea (GB); Julian Richard Davis, Nailsea (GB)

(73) Assignee: Vetco Gray Controls Limited, Nailsea, Bristol (GB)

(21) Appl. No.: 14/367,038

(22) PCT Filed: Dec. 19, 2012
(86) PCT No.: PCT/EP2012/076127

§ 371 Date: Jun. 19, 2014

(30) Foreign Application Priority Data
Dec. 19, 2011 (EP) 11194360.1

(51) Int. Cl. H02J 4/00

(52) U.S. Cl. CPC H02J 4/00
USPC 307/2

(57) ABSTRACT

A system for transmitting alternating current power and communication signals between a first location and a second location via a communication path which includes at least one inductive load and at least one switching means for switching power to said at least one load on and off, the system including control means adapted for controlling said at least one switching means so that, in response to switching off said power, a direct current is applied to said at least one inductive load and, in response to actuation of said at least one switching means to switch said power on, said power is switched on during a phase of the power which results in a magnetization of said at least one inductive load opposite to that resulting from said direct current.

### FIELD OF THE INVENTION

This invention relates to protecting against transients in a communication system, for example in a subsea fluid production well power and communication system.

### BACKGROUND OF THE INVENTION

In subsea fluid production well power and communication systems, the voltage transients inherently associated with power on/off switching of inductive loads are potentially very damaging, because communication modems are directly coupled (connected electrically) to power lines in order to implement communication on power (COP) systems. High voltage transients may damage topside and subsea modems used in COP-based communication systems and topside and subsea power distribution transformers.

### SUMMARY OF THE INVENTION

According to the invention from one aspect, there is provided a system for transmitting alternating current power and communication signals between a first location and a second location via a communication path which includes at least one inductive load and at least one switching means for switching power to said at least one load on and off, the system including control means adapted for controlling said at least one switching means so that, in response to switching off said power, a direct current is applied to said at least one inductive load and, in response to actuation of said at least one switching means to switch said power on, said power is switched on during a phase of the power which results in a magnetization of said at least one inductive load opposite to that resulting from said direct current.

According to the invention from another aspect, there is provided a method for transmitting alternating current power and communication signals between a first location and a second location via a communication path which includes at least one inductive load and at least one switching means for switching power to said at least one load on and off, the method comprising controlling said at least one switching means so that, in response to switching off said power, a direct current is applied to said at least one inductive load and, in response to actuation of said at least one switching means to switching said power on, said power is switched on during a phase of the power which results in a magnetization of said at least one inductive load opposite to that resulting from said direct current.

At least one such inductive load could be at said first location.

At least one such inductive load could be at said second location.

At least one such switching means could be at said first location. At least one such switching means is at said second location.

Said at least one inductive load typically comprises a winding of a transformer.

A system according to the invention typically comprises a power and communication system for a subsea well and a method according to the invention typically is performed in such a system. In these cases, typically said first location is a topside location and said second location comprises a subsea electronics module.

### BRIEF DESCRIPTION OF THE DRAWINGS

FIG. 1 is a schematic diagram of a typical power and communication system for a subsea fluid production well;

FIG. 2 is a schematic diagram of another such power and communication system;

FIG. 3 is derived from oscilloscope traces for illustrating transient problems;

FIG. 4 is a schematic diagram of a first embodiment of a system according to the invention; and

FIG. 5 is a schematic diagram of part of a second embodiment of a system according to the invention.

### DETAILED DESCRIPTION OF THE INVENTION

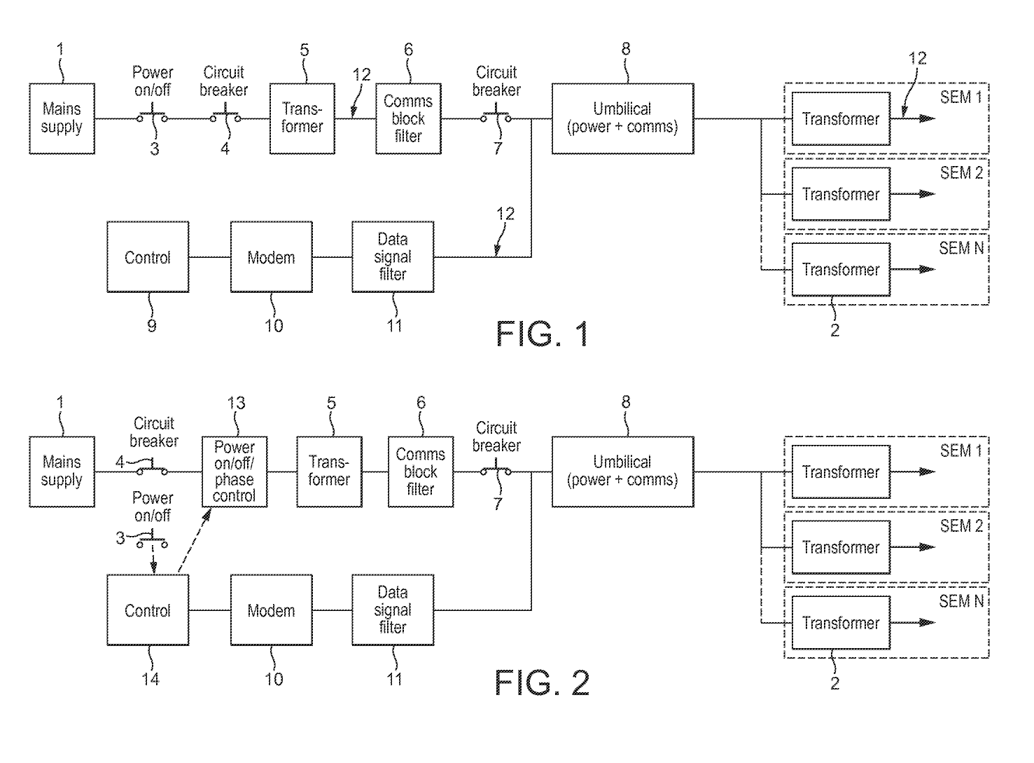

FIG. 1 shows a typical COP-based control system for a subsea fluid (e.g. hydrocarbon) production well in which topside alternating current (AC) mains power from a mains supply 1 (e.g. on a surface platform) is supplied to transformers 2 in subsea electronics modules SEM1, SEM2 . . . SEMN at respective fluid production wells, via a power on/off switch 3, a circuit breaker 4, a topside transformer 5, a communications blocking filter 6, a circuit breaker 7 and an umbilical cable 8 between topside and the subsea wells. Control communications are superimposed under the control of control electronics 9 on to the AC power, after the circuit breaker 7, by a modem 10 and a data signal filter 11. When the power on/off switch 3 or a circuit breaker 4 or 5 is operated, high voltage transients occur at points 12 of the system, which are the result of reactive power being rapidly discharged within the system. The remnant magnetic energy, stored in inductive elements (transformers and inductors) is rapidly discharged through the system and high transient inrush currents occur, with potentially catastrophic consequences.

In FIG. 2 (in which items which correspond with those in FIG. 1 have the same reference numerals as in FIG. 1), power switching in the system is changed by replacing the simple on/off switch 3 by a phase-controlled power on/off switch 13, the action of switch 3 now being via control electronics 14 which control the switch 13 as well as modem 10 and filter 11. More particularly, switch 13 switches power at a controlled phase angle of the voltage waveform, typically via a thyristor or triac. Switching of power on and off is phase-controlled to ensure that the downstream load is powered up on the opposite phase of the supply to that when powered off. For example, if the system is powered on at, as an example, the positive power half cycle of the power, it is always powered off in the negative power half cycle, thus ensuring the delivery of an equal number of positive and negative power half cycles to the load, thereby leaving the downstream magnetic components with a residual magnetic field that should suppress (rather than enhance) the inrush current transient surge generation when the system is next powered on (with the appropriate phase-synchronised power control).

The reason for this process is that switching off the power supply to a transformer results in, typically, a residual magnetic flux stored in the core. If the power is switched on at a part of the AC supply cycle polarity that enhances this flux, then the transformer may go into saturation, resulting in a large input current, and, as there is no longer a change of core flux and thus no back electromotive force (EMF), it is only limited by the resistance of the winding. This high current typically results in severe distortion or collapse of the supply voltage with the rapid change of supply voltage generating harmonics whose frequencies can encroach on the communication band of a COP system and corrupt communications. This, along with potential damage that can be caused by the high inrush currents, can be catastrophic.

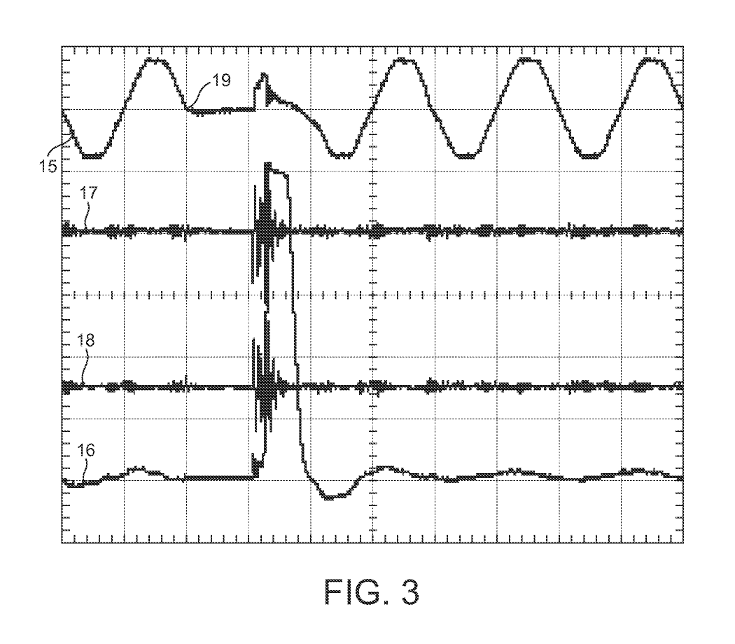

FIG. 3. is derived from actual oscilloscope traces recorded during power on/off tests on a SEM transformer that demonstrates this phenomenon and shows a voltage (trace 15) applied to a primary winding of the transformer, the current (trace 16) in the primary winding, a COP system communication output (trace 17) and a complement (trace 18) of trace 17. The phase point 19 in trace 15 where power is switched on is at the beginning of a negative cycle. It can be seen that there is a large current in the primary winding (trace 16) and a collapse of the supply voltage (trace 15) which has generated harmonics which have resulted in noise bursts in the COP communication channel (traces 17 and 18).

One alternative, simple way to avoid the transients problem is to have a larger core to the transformer so that it will not go into saturation, but this is not an option in subsea equipment where minimisation of mass and volume is essential. The above method of this invention, of ensuring that power on and off is phase-controlled, to ensure that the downstream load is powered up on the opposite phase of the supply to that when powered off, allows retention of transformers with low mass and volume without the risk of transients causing damage and COP communication corruption.

The above solution of the transient problem can, however, be augmented (according to an embodiment of the invention) since, if a circuit breaker opens, or the power is unintentionally cut for any other reason, the power off will not be phase-controlled, and thus the required inverse phase at re-switching on will not be known. This can be dealt with by the addition of pre-magnetization of the transformers. This technique involves applying, temporarily, a small DC voltage to the primary winding of each transformer to set its core remanence in a known direction. This provides knowledge of the phase of the restored AC power required to ‘oppose’ this remanent flux, thus avoiding application of power at a phase which will drive the core flux into saturation and cause transient problems.

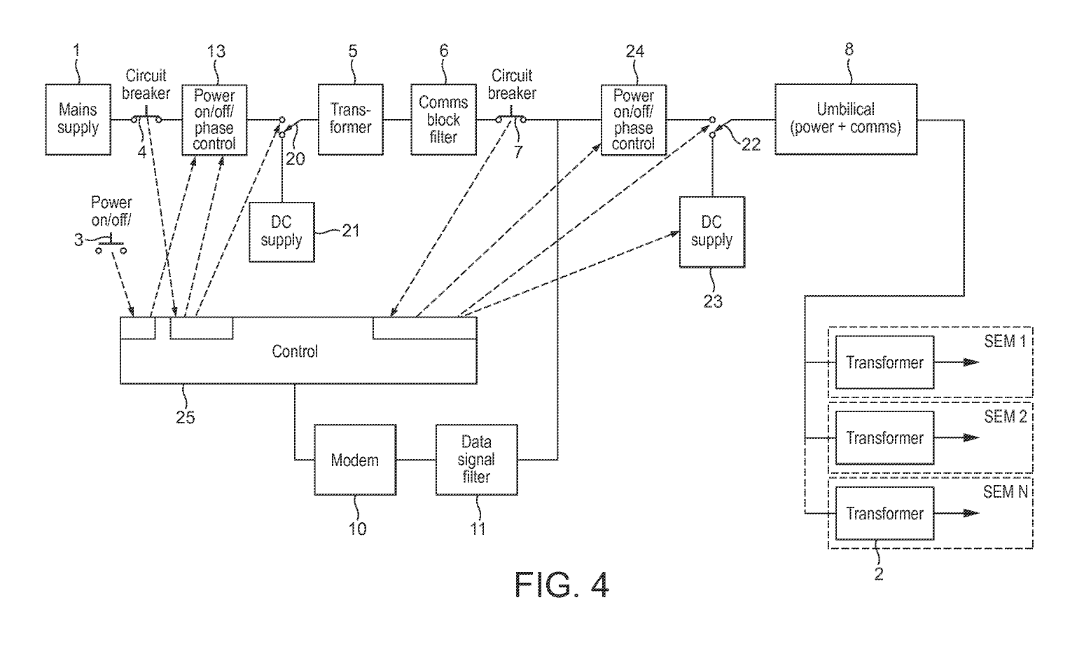

FIG. 4 (in which items which correspond with those in FIG. 2 have the same reference numerals as in FIG. 2) shows the application of this feature to the topside transformer 5. If the circuit breaker 4 opens, a switch 20 between phase-controlled switch 13 and transformer 5 operates for a short period of time and connects a DC supply circuit 21 (typically providing only 9 volts or so) to the primary winding of the transformer 5, thus setting its core remanence in a known direction, dependent on the polarity of the DC supply applied. Following this, the power on/off phase control-led switch 13, is set to apply, when the circuit breaker 4, is reset, the first AC supply phase required to reverse the remanence set by the DC supply circuit 20, thus ensuring that the core of transformer 5 does not go into saturation and thus preventing the problem of high inrush current, supply voltage collapse and corruption of the COP communication which arises without the pre-magnetization technique.

As shown in FIG. 4, the same technique is applied to the subsea transformers 2 housed in the SEMs 1 to N with the DC supply pre-magnetization applied to all the SEM transformers from the topside via the umbilical cable 8. Thus, opening of the circuit breaker 7 (or circuit breaker 4) causes a switch 22 to operate, momentarily connecting a DC supply circuit 23 to the transformers 2 of SEMs 1 to N, followed by the setting of a power on/off phase-controlled switch 24 to apply the correct phase of the AC supply, when re-connected to the transformers, i.e. to reverse the remanent flux in the transformer cores previously pre-set by the DC supply at power off.

The above is effected under the control of topside control electronics 25 acted on by switch 3 and circuit breakers 4 and 7 and connected to control switches 13, 20, 22 and 24.

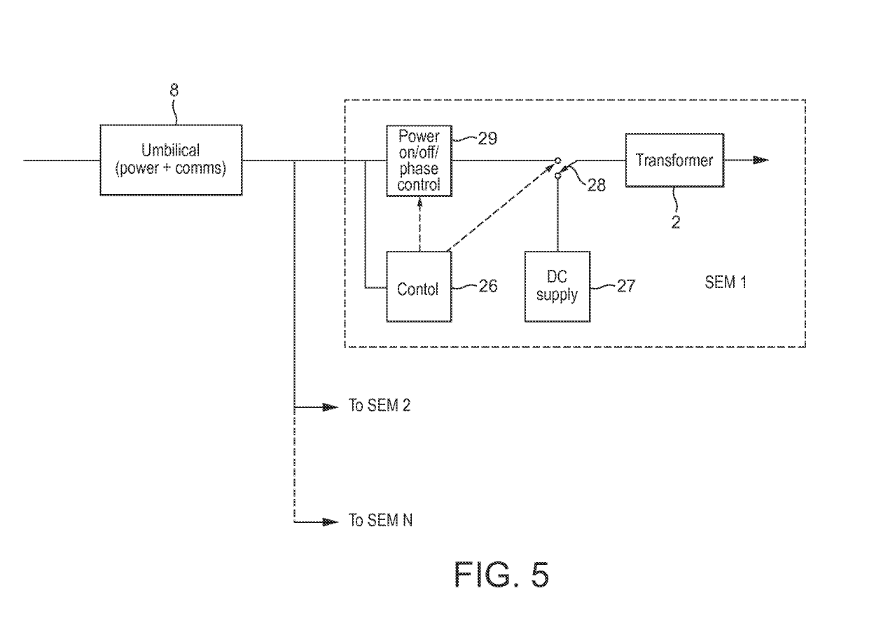

FIG. 5 shows an alternative arrangement to pre-magnetize the transformers in the SEMs by incorporating the required circuitry, power-on phasing and control within each SEM, subsea. In this case in each SEM respectively, control electronics 26 in the SEM will have to have its power supply sustained for a few seconds when the incoming power via the umbilical 8 is switched off, and also contain circuitry to detect switch-off of power, whereupon a DC supply circuit 27 (typically receiving power from the control electronics power supply) is momentarily connected to the transformer 2 by a switch 28. At power restoration via the umbilical 8, a power on/off phase-controlled switch 29 (typically a triac or thyristors) will not restore power to the transformer until the control electronics 26 allows it to switch on at the correct phase of the AC supply.

Embodiments of the present invention allow the use of transformers with flux densities that are close to saturation and therefore low volume and mass, in subsea power systems with COP communications without the problems of system component damage such as modems and corruption of communications when the power supply is switched off or on.

This written description uses examples to disclose the invention, including the preferred embodiments, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system for transmitting alternating current power and communication signals between a first location and a second location via a communication path which includes at least one inductive load, the system comprising:
at least one switch configured to switch power to said at least one inductive load on and off; and
a controller configured to control said at least one switch to switch power on and off so that, (i) in response to switching said power off, a direct current is applied to said at least one inductive load, and (ii) in response to switching said power on, said power is switched on during a phase of the power which results in a magnetization of said at least one inductive load opposite to that resulting from said direct current.

2. The system according to claim 1, wherein said at least one inductive load is at said first location.

3. The system according to claim 1, wherein said at least one inductive load is at said second location.

4. The system according to claim 1, wherein said at least one switch is at said first location.

5. The system according to claim 1, wherein said at least one switch is at said second location.

6. The system according to claim 1, wherein said at least one inductive load comprises a winding of a transformer.

7. The system according to claim 1, further comprising a power and communication system for a subsea well.

8. The system according to claim 7, wherein said first location is a topside location, and said second location comprises a subsea electronics module.

9. A method for transmitting alternating current power and communication signals between a first location and a second location via a communication path which includes at least one inductive load and at least one switch configured to switch power to said at least one inductive load on and off, the method comprising:
controlling said at least one switch to switch power on and off so that, (i) in response to switching said power off, a direct current is applied to said at least one inductive load, and (ii) in response to switching said power on, said power is switched on during a phase of the power which results in a magnetization of said at least one inductive load opposite to that resulting from said direct current.

10. The method according to claim 9, wherein said at least one inductive load is at said first location.

11. The method according to claim 9, wherein said at least one inductive load is at said second location.

12. The method according to claim 9, wherein said at least one switch is at said first location.

13. The method according to claim 9, wherein said at least one switch is at said second location.

14. The method according to claim 9, wherein said at least one inductive load comprises a winding of a transformer.

15. The method according to claim 9, wherein the method is performed in a power and communication system for a subsea well.

16. The method according to claim 15, wherein said first location is a topside location, and said second location comprises a subsea electronics module.
